(19) United States
(12) Patent Application Publication
(10) Pub. No.: US 2008/0115079 A1
(43) Pub. Date: May 15, 2008

(54) SYSTEMS AND METHODS FOR DYNAMIC DISPLAY OF ORDERS

(75) Inventor: Timothy S. Mather, Englewood, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: CQGT,LLC, Denver, CO (US)

(21) Appl. No.: 11/935,839

(22) Filed: Nov. 6, 2007

Related U.S. Application Data
(60) Provisional application No. 60/858,168, filed on Nov. 10, 2006.

(51) Int. Cl. G06F 3/048; G06F 17/21; G06Q 40/00

(52) U.S. Cl. 715/774; 705/36 R; 715/273

(57) ABSTRACT

Systems and methods for dynamic display of orders and trades are provided. Financial instrument data is received from an electronic exchange or a pre-processing application. The financial instrument data may include a variety of information, such as, bid orders, ask orders, sell orders, cancelled orders, and the like. A scrolling trade and order display with a first axis representing a time and a second axis corresponding to a portion of a depth of market for the financial instrument is displayed on a display device. Financial instrument data is then dynamically presented on the scrolling trade and order display in one or more indicative formats to visually indicate information about the data being presented. Examples of indicative formats include coloring text, changing background colors, using strikethrough lines, different fonts, placements of information, linking symbols, and the like.

### CROSS-REFERENCE TO RELATED APPLICATIONS

This application claims the benefit of Provisional Application No. 60/858,168, filed on Nov. 10, 2006, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006-2007 CQGT, LLC.

### TECHNICAL FIELD

Various embodiments of the present invention generally relate to the presentation of information. More specifically, embodiments of the present invention relate to systems and methods for the dynamic display of orders and trades.

### BACKGROUND

In the field of financial trading, trading of financial instruments (e.g., securities, commodity, currency, or index futures, options, etc.) is typically done today through an electronic exchange, rather than on the historical “trade floor”. Trading through an electronic exchange enables virtually anyone with a computer to trade directly with the exchange. Via a trader's computer that accesses the exchange via a network, the trader can obtain real-time or historical financial data, place orders (e.g., market, stop, limit, or stop limit orders) to buy or sell a financial instrument, perform a wide range of financial analyses, and much more. In addition, data can be presented to the trader in various useful formats, such as graphical or alphanumeric. The manner of presentation of data and the interface through which the trader enters orders to the market are typically very important to traders because they can effect timeliness of data presentation, the timeliness of order entry, the ability of the trader to observe and capitalize on market trends, and so on.

Of course, traders would prefer to be able to predict future prices with a high degree of confidence in order to increase their chances of profitability. Thus, the useful presentation of financial data is critical. In addition, traders prefer a trading interface through which trades can be effectively entered in a visually satisfying manner.

A common trading interface presents the depth of market (DOM) of a single financial instrument in a table (referred to as a DOM table), with current bid and ask volumes which represent the accumulation of all resting order volume shown at corresponding prices. For example, each ask volume and each bid volume value may be in a row that includes the corresponding price. Traditional scrolling tickers, for example, typically aggregate trades from multiple financial instruments. Neither of these traditional user interfaces includes information which may indicate trends or market desires. A trader using these displays must rely upon memory to infer the market direction

As such, there are a number of challenges and inefficiencies created in the presentation of information about financial products through traditional displays. Thus, the trader is not able to use all the available information about the financial product. It is with respect to these and other problems that embodiments of the present invention have been made.

### SUMMARY

Systems and methods are described for the dynamic display of orders and trades. More specifically, embodiments of the present invention relate to systems and methods for dynamic display of orders and trades as orders enter the market. The dynamic display of orders and trades allows for the presentation of the information through the use of various indicative formats. Examples of indicative formats include, but are not limited to, fonts, colors, background colors, placements, linking symbols, and the like providing traders with a convenient way to monitor the order and trade flow of financial instruments.

In some embodiments, financial instrument data about a financial instrument is received from an electronic exchange or pre-processing application. The financial instrument data may include information about a depth of market, an inside market, bid orders, sell orders, cancelled orders, new orders, completed trades, bid volumes, ask volumes, trade volumes, and the like.

A scrolling trade and order display with a first axis representing a time and a second axis corresponding to a portion of a depth of market for the financial instrument may be displayed. Some embodiments of the present invention can include a dotted line across the scrolling trade and order display surrounded by a colored band highlighting an inside market associated with the financial instrument. The dotted line and the colored band remains statically positioned on the scrolling trade and order display in one or more embodiments.

The financial instrument data is then dynamically presented on the scrolling trade and order display in one or more indicative formats. Some examples of indicative formats include, but are not limited to, bright green text on a dark green background for an ask, bright red text on a dark red background for a bid, black text on a bright green background for a trade executed at the best ask price, gray text for a cancelled order, gray text with a green strikethrough for a cancelled bid, gray text with a red strikethrough for a cancelled ask, gray text with green strikethrough followed by bright green text on a dark green background with identical text for a modified bid, and gray text with a red strikethrough followed by bright red text on a dark red background with identical text for a modified ask.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

FIG. 1 illustrates an operating environment in which embodiments of the present invention may be employed;

FIG. 2 is a block diagram of various components in a trading application that uses a dynamic display of orders and trades as orders enter the market in accordance with various embodiments of the present invention;

FIG. 3 illustrates a display of orders and trades in accordance with one or more embodiments of the present invention;

FIG. 4 is a flow chart illustrating operations for generating a display of orders and trades which may be used in accordance with one or more embodiments of the present invention;

FIG. 5 illustrates the display of orders and trades in FIG. 2 after which the display has been resized;

FIG. 6 illustrates an example of a graphical user interface for adjusting parameters that control the rendering of the display of orders and trades in accordance with one or more embodiments of the present invention; and

FIG. 7 illustrates an example of a computer system with which embodiments of the present invention may be utilized.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to the presentation of information. More specifically, embodiments of the present invention relate to systems and methods for the dynamic display of orders and trades as orders enter the market. A trader of financial instruments may desire to monitor the ebb and flow of orders for a financial instrument. Historically, real-time information about the financial instrument order book or depth of market was not available from the financial market. Today, however, electronic exchanges publish changes to the order book as well as trades that have occurred within the market in a real-time manner. Using this information, a more detailed account of how the market is changing can be provided to the trader. Traditional electronic order book displays present the price and volume information in a tabular manner, showing only the instantaneous values without any visibility of the history on the order flow. To provide this history, however, more effective display mechanisms are needed. Accordingly, various embodiments of the present invention present changes in the order book or depth of market in conjunction with executed trades through the use of various indicative formats, such as fonts, colors, background fonts, placements, linking symbols, and the like providing traders with a convenient way to monitor the order flow of financial instruments.

Embodiments of the present invention allow for information such as, but not limited to, depth of market, inside market, bid orders, sell orders, cancelled orders, new orders, completed trades, ask volume, bid volume, trade volume, bid/ask range, as well as other information to be organized and presented to a trader though a dynamic display of orders and trades. In accordance with various embodiments, the information presented on the dynamic display of orders and trades, for example, may be color coded, presented in various font types and colors, have different background colors, have linking symbols connecting information, visually grouped, and presented in different locations on the dynamic display of orders and trades.

In various embodiments of the present invention, a trading application may be used by a trader to customize the financial information which is presented on a dynamic display of orders and trades. In some cases, the trader is able to customize how the information is presented, encoded, and/or or arranged on a dynamic display of orders and trades. For example, the default setting may be that ask orders are presented with a font color of red. However, using embodiments of the present invention, a user may be able to change the color of ask orders to another color specified by the user.

In some embodiments, a trading application may produce multiple dynamic displays of orders and trades. In some of these embodiments, the user is able to select the type of information which will be presented on each ticker. The trading application may then sort, organize, arrange, and present the information on the dynamic displays of orders and trades based on the preferences set by the user.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to trading financial instruments, embodiments of the present invention are equally applicable to various other areas where the display of information may be beneficial. For example, embodiments of the present invention may be used in the context of reporting information on, or betting systems for, sporting events such as baseball, football, soccer, hockey, horse racing, as well as others.

For the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices, systems, and infrastructure. In addition, embodiments are applicable to all levels of computing from the personal computer to large network mainframes and servers.

### Terminology

Brief definitions of terms, abbreviations, and phrases used throughout this application are given below.

The term “ask” for a particular financial instrument generally refers to a limit or stop/limit sell order placed at a price higher than the current market price.

The phrase “ask volume” generally refers to the number of shares or contracts of a financial instrument available for trading at an ask price.

The term “bid” for a particular financial instrument generally refers to a limit or stop/limit buy order placed at a price lower than the current market price.

The phrases “bid/ask range” or “inside market” for a particular financial instrument refers to the price region bounded by the currently established best or highest bid price and the currently established best or lowest ask price.

The phrase “bid volume” generally refers to the number of shares or contracts of a financial instrument available for trading at a bid price.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrase “depth of market”(DOM) refers to the quantity of a financial instrument available for trading at a number of ask prices and bid prices around and including the inside market. For example, in some embodiments, the DOM includes the number of shares or contracts available for trading at a number of ask prices and bid prices around and including the inside market. The “depth of market” is sometimes referred to as the order book.

The terms and phrases “embodiment,” “according to various embodiments,” and the like generally mean the particular feature, structure, or characteristic following the phrase is included in at least one embodiment of the present invention, and may be included in more than one embodiment of the present invention. Importantly, such phases do not necessarily refer to the same embodiment.

The term “financial instrument” generally refers to anything that can be traded with quantities and/or prices. Examples of financial instruments include, but are not limited to, securities, commodity, currency, or index futures, options, and treasuries that are either bought or sold by specifying a price and a quantity. Other examples include stocks, bonds, mutual funds, Exchange-Traded Funds (EFTs), stock futures, commodity futures, stock options, commodity options and the like.

The phrases “memory store” or “data store” generally refer to any device, mechanism, or populated data structure used for storing information. For purposes of this patent application, “memory store” or “data store” are intended to encompass, but are not limited to, one or more databases, one or more tables, one or more files, volatile memory, nonvolatile memory and dynamic memory. By way of further illustration, for example, random access memory, memory storage devices, and other recording media are covered by the phrase “memory store” or “data store.” Common examples of a memory store include, but are not limited to, magnetic media such as floppy disks, magnetic tapes, hard drives and/or the like. Other examples of “memory stores” include SIMMs, SDRAM, DIMMs, RDRAM, DDR RAM, SODIMMS, optical memory devices such as compact disks, DVDs, and/or the like. In addition, a “memory store” may include one or more disk drives, flash drives, databases, local cache memories, processor cache memories, relational databases, flat databases, and/or the like. This list is no way meant to be an exhaustive list of devices and/or data structures falling with in the definition of “memory store,” but is instead meant to highlight some examples. Those skilled in the art will appreciate many additional devices and techniques for storing information which are intended to be included within the phrase “memory store.”

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “responsive” includes completely and partially responsive.

The term “trade” for a particular financial instrument generally refers to a transaction between a buyer and a seller at a mutually agreed price. A trade is transacted at the best ask price when a market order is entered by a buyer. A trade is transacted at the best bid price when a market order is entered by a seller.

The term “trader” generally refers to any person, electronic device, and/or mechanical device that uses an input device, computerized or otherwise, to place trade orders, either to buy or to sell a specific quantity of a financial instrument, into a market place.

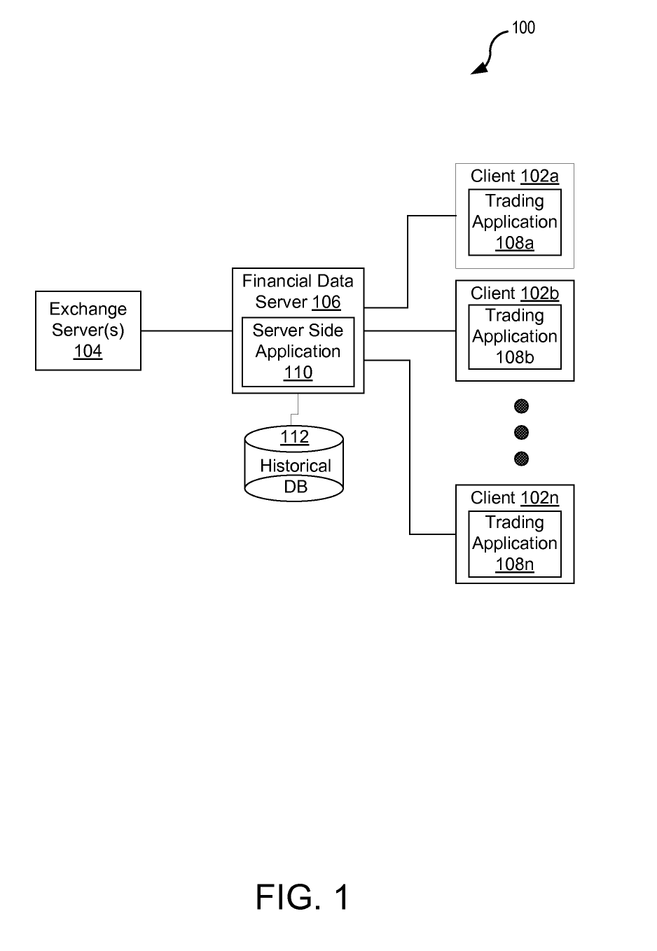

FIG. 1 illustrates an operating environment 100 in which embodiments of the present invention may be employed (and/or be a part of, in whole or part). One or more traders use client computers or terminals 102a-n to analyze data and place trade orders at electronic exchange server(s) 104. The electronic exchange server(s) 104 are servers associated with the electronic exchange that accept trade orders, provide requested data, provide a substantially real-time stream of bid, ask, and trade prices and volumes, and other data manipulation related to the electronic exchange. The clients 102a-n communicate with the electronic exchange via financial data server(s) 106 that facilitate communication of financial data and placement of trade orders.

Trading applications 108a-n operate on clients 102a-n, respectively. Trading applications 108a-n each gather financial data, process the data, present selected data to the trader on a display (not shown), receive input from the trader, and transmit trade orders to the server 106. More specifically, the trading applications 108a-n communicate with a server side application 110. The server side application 110 is operable to obtain selected data from the exchange server(s) 104 and communicate data to the exchange server(s) 104. Data communicated to the exchange server(s) 104 may be, for example, elements of trade orders, such as buy or sell, quantity, stop or limit prices, or others.

In the embodiment shown, financial data server 106 utilizes a database 112 for storing data, such as historical price and volume data. Server application 110 and client applications 108a-n can use and present real-time data and historical data from historical database 112. The database 112 may store data in any form suitable for the particular implementation, such as, but not limited to, a relational database and flat files. As such, the database 112 may or may not be accessed via a structured query language (SQL), for example. In addition, financial data server 106 can include cache memory (not shown) for caching selected data, which may be used again later. The server 106 may at times remove selected data from the cache, based on caching rules.

In some embodiments, clients 102a-n can subscribe to selected financial instruments, and financial information, or services. Clients 102a-n, financial data server 110, and exchange server(s) 104 communicate via one or more networks. The networks may be wireless, wired, or a combination of wired and wireless. Network components (not shown) and/or components at the clients 102a-n, financial data server 110, and exchange server 104, such as firewalls and network address translators (NATs), may provide for data and system security.

Data communicated between the clients 102a-n and the financial data server 106, and between the financial data server 106 and the exchange server(s) 104 may be “pushed” or “pulled”, or any combination thereof, depending on the situation. For example, akin to pulling, the client 102a may request historical data from the financial data server 106, which will prompt the server side application 110 to retrieve the requested data from the database 112 and send the data to the client 102a. On the other hand, real-time data from the exchange server(s) 104 is typically pushed to one or more of the clients 102a-n by the server side application 110.

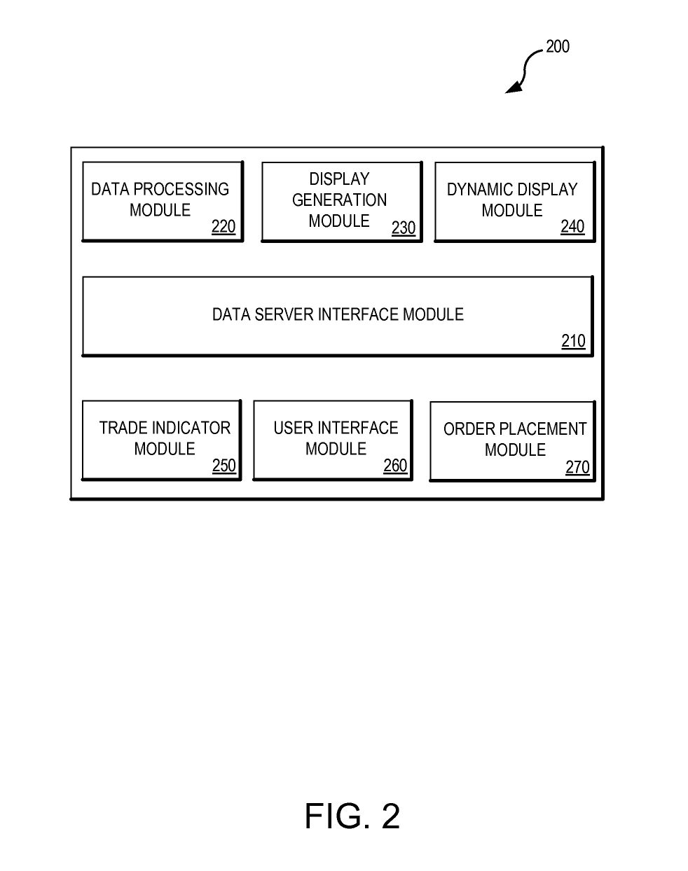

FIG. 2 is a block diagram of various components in a trading application 200 that uses a dynamic display of orders and trades as orders enter the market in accordance with various embodiments of the present invention. According to the embodiment shown in FIG. 2, trading application 200 includes an data server interface module 210, a data processing module 220, an display generation module 230, a dynamic display module 240, a trade indicator module 250, a user interface module 260, and an order placement module 270. Other embodiments of the present invention may include some, all, or none of these modules along with other modules or application components. Still yet, various embodiments may incorporate two or more of these modules into a single module and/or associate a portion of the functionality of one or more of these modules with a different module. For example, in various embodiments, data server interface module 210 and data processing module 220 may be combined into a single processing module and may be included in an application other than trading application 200.

Data server interface module 210, according to some embodiments, provides an interface between the trading application and financial data server 106, financial exchange server(s) 104, and/or a trading gateway. Financial exchange interface module 210 translates any requests from the trading application into a format required by the destination component. Similarly, module 210 is able to translate and/or direct incoming requests and/or data to the appropriate module within the trading application. Many electronic exchanges provide changes in the depth of market of one or more financial instruments. For example, when a twenty-five lot limit order is added to the order book at an asking price of 170010, for some financial exchanges an order descriptor that includes the price and quantity of the order is pushed from the electronic exchange server(s) while other exchanges push a change indicator that includes the new volume available for trading at the asking price. In some embodiments, the electronic exchanges provide a real-time, substantially real-time stream, or periodic batch of bid, ask, and/or trade prices and volumes.

Once data is received through financial data server interface module 210, data processing module 220 processes the data. In some embodiments, a trader using trading application 200 may select one or more preferences about how to process the data being received. Data processing module 220 can sort, organize, filter, select, and/or otherwise process the data according to the trader's preferences. For example, incoming data may include information about multiple financial instruments. Data processing module 220 can sort the data by financial instruments. In some embodiments, data processing module 220 receives financial instrument data from the data server interface module 210 and filters out all financial instrument transactions less than a pre-set quantity.

In some cases, a trader may prefer to see data averaged over a certain time interval (e.g., three seconds, five minutes or hourly). Consequently, in some embodiments, data processing module 220 can aggregate multiple transactions over the certain time interval. In all these cases, and others, data processing module 220 processes the data received from the financial exchange based on system preferences or rules. Module 220 then communicates the results to other modules, such as, but not limited to display generation module 230 and/or dynamic display module 240.

Display generation module 230 generates and presents a scrolling trade and order display to a trader through a display device. According to various embodiments, the scrolling trade and order display may include a price scale axis corresponding to a portion of a depth of market for the financial instrument and a time scale. In some embodiments, the depth to be displayed is five prices above the inside market representing the asks and five prices below the inside market representing the bids. However, the depth of market extent may be more or less in other embodiments of the present invention. In addition to the price scale axis, the scrolling trade and order display may include a line, possibly dotted, spanning the entire time span displayed on the module. In some embodiments, the line is surrounded by a colored band highlighting an inside market associated with the financial instrument.

Dynamic display module 240 renders information about orders and/or trades that have been placed with the financial exchange and that has been broadcast by the exchange server 104. In some embodiments, dynamic display module 240 receives financial data from data processing module 220. In various embodiments, data processing module 220 takes the information transmitted by a financial exchange and determines if the information includes one or more transaction descriptors. Examples of transaction descriptors include, but are not limited to, a trade descriptor, a new order descriptor, an order cancellation descriptor, or a change descriptor to be applied to the depth of market. If the information is a trade descriptor, the data processing module 220 passes it to the dynamic display module 240 to update the scrolling trade and order display. If the transmitted information is a depth of market change descriptor, the order processing module generates either a new order descriptor or an order cancellation descriptor.

Data processing module 220 receives the new order or cancellation descriptor and then determines whether it relates to an order already displayed on a scrolling trade and order display. According to some embodiments, data processing module 220 looks for a matching price and quantity currently being displayed. If a match is found, then the displayed order text is updated with the appropriate indicative format to indicate what has happened. If the new order or order cancellation descriptor does not correspond to an order currently being displayed, then it is presented as a new transaction in the appropriate indicative format. Dynamic display module 240 updates information already presented on the scrolling trade and order display accordingly.

For example, if a bid which has previously been presented on the scrolling trade and order display is removed or executed, then the information on the scrolling display is updated. In some embodiments, if the bid has been removed, then a line may be placed through financial data presented on the scrolling trade and order display corresponding to the bid quantity. Additionally, in various embodiments, dynamic display module 240 is also responsible for assigning one or more of the various indicative formats to the data being presented. For example, the display module may set the fonts, colors, background colors, placements, linking symbols, and the like which provides traders with a convenient way to monitor the order flow of financial instruments.

Some embodiments of the present invention include trade indicator module 250. Trade indicator module 250 displays a trade direction marker on the price scale axis corresponding to a trade direction. In some embodiments, the trade direction marker is an arrow. The arrow may be emphasized by line size, boldness, color, or other feature to indicate the amount of pressure on the trade direction.

The user interaction with the trading application and/or scrolling trade and order display is facilitated by user interface module 260. Various embodiments of user interface module 260 allow for user interaction with the trading application using a computer mouse as an input device. There are also numerous different types of computer mice: two button, three button, having a mouse wheel or roller ball, etc. According to various embodiments, user interface module 260 is able to determine the type of mouse being used and translate actions appropriately. For example, movement of the mouse wheel may adjust the depth of market being displayed on the scrolling trade and order display. Other embodiments, however, provide for other input devices such as, but not limited to, a track ball, a keyboard, audio input (e.g., with speech recognition), and/or a touch screen input (e.g., with a stylus). The invention is not limited to any particular type of input device, or any particular type of mouse.

According to various embodiments, order placement module 270 is responsible for order placement from the trader using trading application 200. In some embodiments, the scrolling trade and order display may be used by the user to directly place orders. As one example, a trader may use a mouse to double click on a particular price on the scrolling trade and order display. The trader may then use the scroll wheel to update the desired quantity of the transaction to be place.

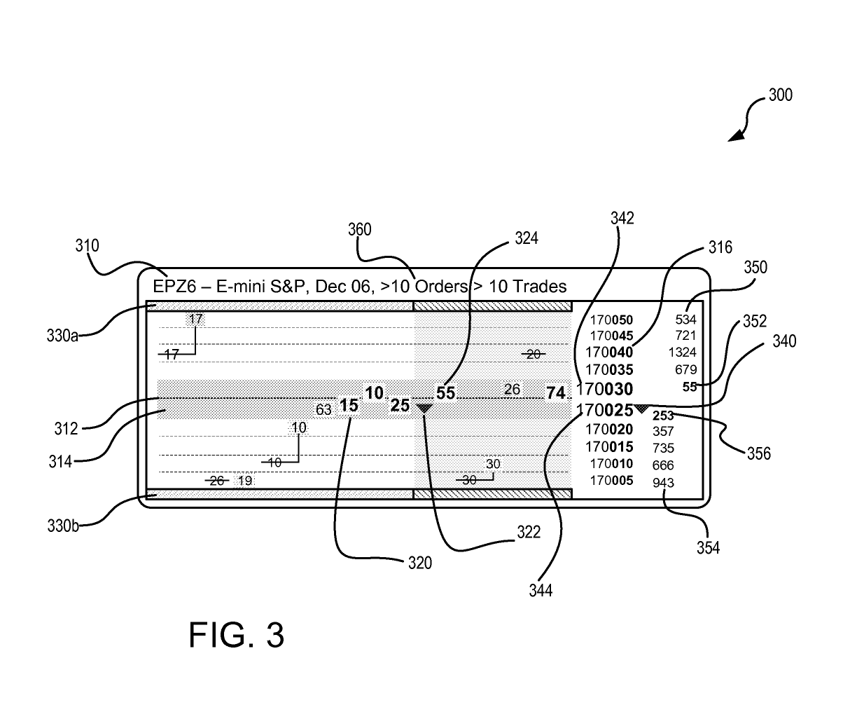

FIG. 3 illustrates a dynamically scrolling display 300 of orders and trades in accordance with one or more embodiments of the present invention. According to various embodiments, the scrolling display 300 of orders and trades may be generated by a trading application using data provided by the exchange. For example, trading applications 108a-n gathering financial data may process, sort, and format the data before the data are presented to the trader on a dynamically scrolling display 300.

According to various embodiments, information about financial instruments can include, but is not limited to, depth of market, inside market, buy orders, sell orders, cancelled orders, new orders, executed trades, ask volume, bid range, as well as other information that may be organized and presented to a trader on a dynamically scrolling display of orders and trades. The trading application 108a, may process and format the information which will be presented on the dynamically scrolling display 300. In some embodiments, for example, trading applications may color code the data, present data in various font types and colors, create different background colors, generate linking symbols connecting information, visually group information, and present data at different locations on the dynamic scrolling trade and order display.

In accordance with various embodiments, a dynamically scrolling display of orders and trades has two axes: a first axis that roughly relates to time, and a second axis that relates to a portion of the depth of market for a financial instrument. In one or more embodiments, trade and order quantity data scroll along the first axis, as the data are received from the exchange and processed and formatted. Although embodiments described herein scroll the data horizontally, the invention is not so limited, and in other embodiments the data may scroll along other axes, such as a vertical axis.

In the embodiment depicted in FIG. 3, trade and order volume data points scroll horizontally from right to left, such that the right most data are the newest data, and the left most data are the oldest data. In the embodiment depicted, the trade and order volume data points are aligned with prices on the price scale 316 corresponding to the trade or order price.

According to various embodiments of the present invention, the inside market, marked by the dotted line 312 and by the darker grey band 314 in FIG. 3, remains statically positioned in the middle of the scrolling trade and order display window 310. As the inside market moves higher, the prices displayed in the price scale 316 are dynamically adjusted to reflect the current state of the inside market. In some embodiments, the size of the font used to display a price in the price scale 316 may vary depending on the proximity of the price to the inside market. For example, prices at or near the inside market may be displayed with a larger font than prices more distant from the inside market. Further, in some embodiments, the most significant digits of the price might be displayed using a bold font and/or an alternate color.

Transitions of the inside market can be indicated on the scrolling trade and order display. In some embodiments of the present invention, if the inside market moves down, a downward pointing triangle or arrowhead 322 is displayed below the dotted line 312 that marks the inside market. If the inside market moves up, an upward pointing triangle or arrowhead is displayed above the dotted line 312 that marks the inside market. In alternative (or overlapping) embodiments, the directional arrowheads may be colored to better emphasize market direction. For example, a downward pointing arrowhead indicating a downward movement of the inside market might be colored red while an upward pointing arrow indicating an upward movement of the inside market might be colored green. In other (or overlapping) embodiments, different geometrical shapes (e.g., polygons, triangles, quadrilaterals, rectangles, squares, rhombus, trapezoids, hexagons, circles, etc) may be used to indicate that the inside market has moved. The shapes may be different depending on whether the inside market has moved up or down. For example, a heptagon when the market moves up and a trapezoid when the market moves down.

The scrolling trade and order display example shown in FIG. 3 illustrates a shift in the inside market. To the left of the marker 322 (representing a prior time), the inside market was delimited by a best ask price of 170035 and a best bid price of 170030. Later, the inside market moved down to the current position delimited by a best ask price of 170030 and a best bid price of 170025. In some embodiments, the display is divided into two or more sections to indicate when the inside market shifted relative to orders and trades being displayed. In the embodiment of FIG. 3, there are two sections, each having a different overall background color. For example, the background of the dynamic display changes colors (e.g., alternately between white and gray) when the inside market shifts and causes price scale 316 to dynamically adjust.

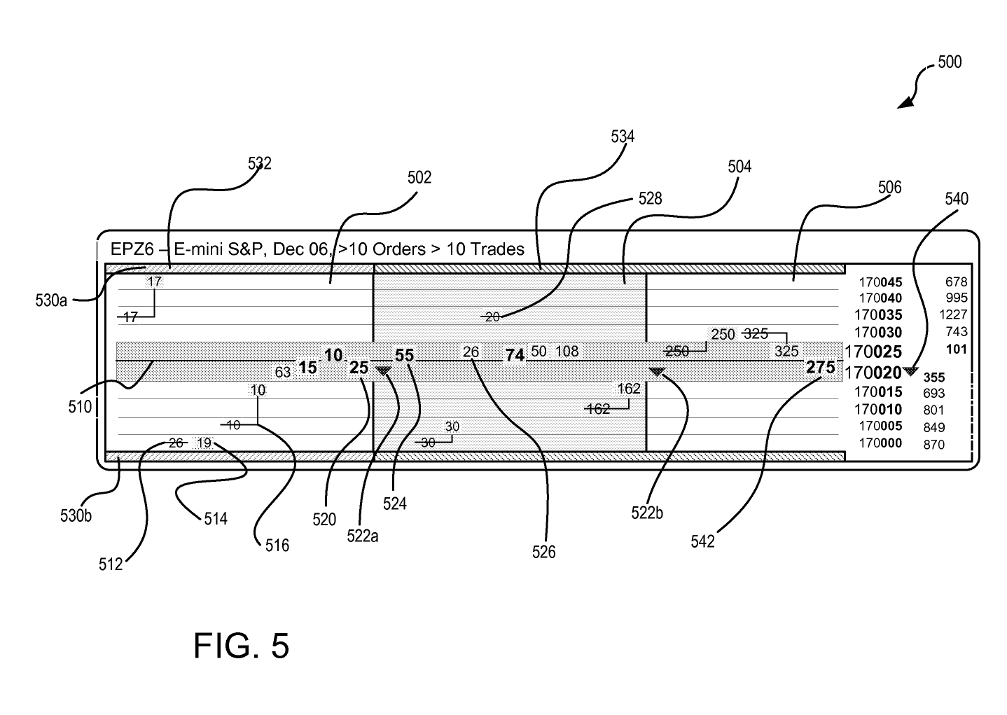

The scrolling trade and order display shown in FIG. 3 also includes market direction indicators 330a and 330b which visualize market direction over time. At each inside market transition point, it can be determined if the market is proceeding in the same direction, either up or down, as for the previous inside market transition. If the transition is a continuation of the market direction, either up or down, the color or pattern of the market direction indicator remains unchanged. If a reversal of the market direction is indicated, the color or the pattern is changed to reflect the change. In some embodiments of the present invention, an upward direction of the inside market is indicated by coloring the market direction indicator green and a downward direction is indicated by coloring the market direction indicator red. The market direction indicators are illustrated in more detail in FIG. 5.

The scrolling trade and order display shown in FIG. 3 also includes the depth of market volumes for each market price displayed. Ask volumes are displayed in column 350 and bid volumes are displayed in column 354. In some embodiments, the volumes at the inside market might be highlighted using bold fonts and/or different fond colors. For example, the ask volume 352 may be colored red and bid volume 356 may be colored green.

Continuing with the illustrative scenario shown in FIG. 3, trade and order quantity data are shown in a format that is indicative of the event. According to various embodiments, various combinations of font size, font weight, font color, background pattern or background color may be used. Some examples of formats and their corresponding meaning as illustrated in FIG. 3 are listed here:

Normal text on a more densely speckled background: an ask

Normal text on a more lightly speckled background: a bid

Bold text a densely speckled background: a trade executed at the best ask price

Bold text on a lightly speckled background: a trade executed at the best bid price

Normal text with a strikethrough positioned above the dotted line 312:
a cancelled bid

Normal text with a strikethrough positioned below the dotted line 312:
a cancelled ask

Normal text with a strikethrough and a line connecting to normal text on a densely speckled background positioned above the dotted line 312:
a modified bid

Normal text with a strikethrough and a line connecting to normal text on a more lightly speckled background positioned below the dotted line 312:
a modified ask

While not illustrated in FIG. 3, other embodiments of the present invention allow for other formats to be used. The following are some examples of formats and their corresponding meaning in accordance with one or more alternative (or overlapping) embodiments:

Bright green text on a dark green background: an ask

Bright red text on a dark red background: a bid

Black text on a bright green background: a trade executed at the best ask price

Black text on a bright red background: a trade executed at the best bid price

Gray text with green strikethrough: a cancelled bid

Gray text with red strikethrough: a cancelled ask

Gray text with green strikethrough followed by bright green text on a dark green background with identical text: a modified bid

Gray text with red strikethrough followed by bright red text on a dark red background with identical text: a modified ask

The above list of formats and events are provided merely for illustration of some embodiments of the present invention. The invention is not limited to the events and/or formats described above. In addition, the meanings of the formats may be different than those shown above in some embodiments. In fact, in some embodiments, the events and their corresponding formats can be configured by the user.

As illustrated in FIG. 3, the value fifteen (320) represents the volume of a trade that was executed at the best bid at a time when the best bid price 170030. The value fifty-five (324) represents the volume of a trade that was executed at the best ask after the inside market had moved down and the best ask price has become 170030. The meaning of the various trade and order data points is further elaborated in the discussion of FIG. 5 that follows.

Also included in the embodiment illustrated in FIG. 3 is a last trade direction marker 340. If the last trade was executed at the best ask price, then an upward pointing triangle or arrowhead is displayed to the right of the best ask price. If the last trade was executed at the best bid price, then a downward pointing triangle or arrowhead is displayed to the right of the best bid price. In alternative (or overlapping) embodiments, the directional arrowheads (or other geometrical shapes) may be colored to better emphasize market direction. For example, a downward pointing arrowhead indicating a trade at the bid might be colored red while an upward pointing arrow indicating a trade at the ask might be colored green. In alternative (or overlapping) embodiments, the last trade direction marker 340 may not be used in order to minimize unused display space. Instead, for example, the last trade direction may be indicated by coloring the best ask price 342 green when a trade occurs at the ask and coloring the best bid price 344 red if the last trade occurs at the bid.

Another feature of the embodiments illustrated in FIG. 3 is documented by the text “>10 Orders>10 Trades”(350). In general, the phrase “>m Orders>n Trades”, where ‘m’ and ‘n’ are integer numbers, refers to a filter to be applied to received orders and trades, such that only orders with sizes of ‘m’ or more and/or trades with sizes of n′ or more are displayed on the order display 300. This represents the feedback that the quantity filters has been set to have the value of ten for both order and trades, as is elaborated in the discussion below.

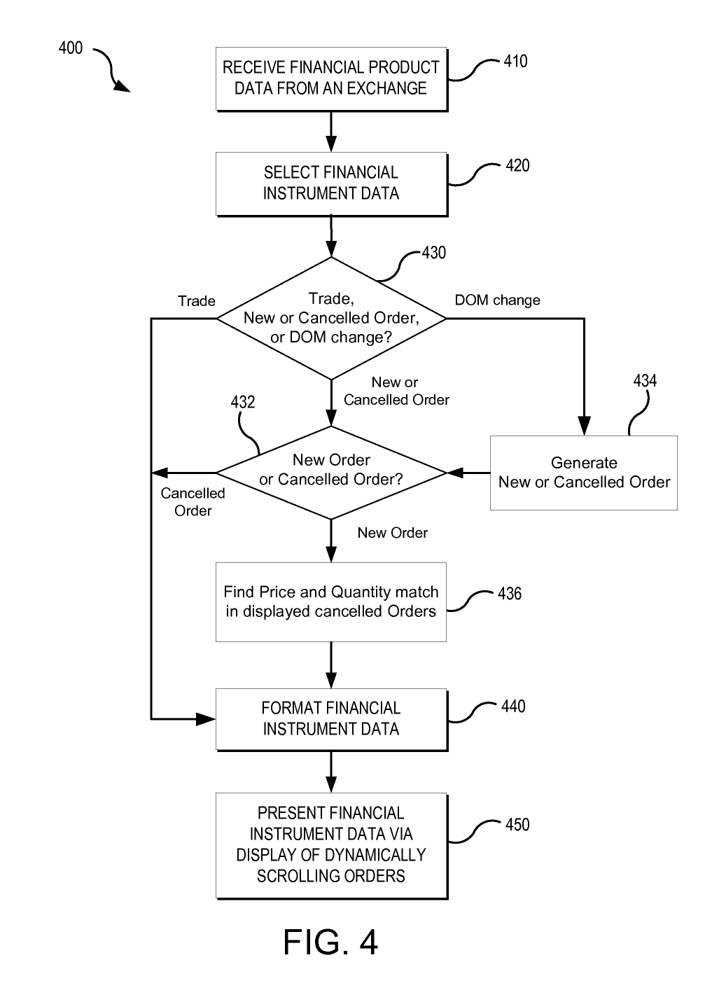

FIG. 4 is a flow chart illustrating operations for generating a dynamic order display in accordance with embodiments of the present invention. According to various embodiments, receiving operation 410 receives financial data information which is being pushed from a financial data server. This information may be raw data or processed data based upon subscription rights and privileges to the financial server. The data may be related to numerous different financial instruments. In some embodiments, the raw data received from the financial server corresponds to trades, new orders, order cancellations or changes in the order book of one or more financial instruments. For example, the data may indicate that an ask order with a quantity of ten has been removed at a price 171010.

A selecting operation 420 selects the data associated with the financial instrument of interest. Typically, the user chooses the financial instrument of interest. In the example shown in FIG. 4, a determining operation 430 receives data from the selecting operation 420 and determines whether the data represents a trade, a new order, an order cancellation, or a change to be applied to the depth of market. If the determining operation 430 determines that the data represent a trade, the next step will be formatting operation 440. If the determining operation 430 determines that the data represent a new order or a cancelled order, the next step will be order matching operation 432. If the determining operation 430 determines that the data represents a depth of market (DOM) change, the next step is to first proceed to the order generation operation 434 and then to the order matching operation 432. The order generation operation 434 converts an increase of the volume at a price in the DOM to a new order or a decrease in the volume at a price in the DOM to an order cancellation.

The determining operation 432 receives either a new order or an order cancellation from either the determining operation 430 or the order generation operation 434. If the data received by the determining operation 432 represents a cancellation, the next step is to proceed directly to the formatting operation 440. If the data received by the determining operation 432 represent a new order, the next step is to proceed to the order matching operation 436 which searches through currently displayed cancelled orders to determine if there is a quantity match at a different price. If a quantity match is found, the new order is determined to be a modification of a cancelled order and the order pair is presented to the formatting operation 440.

The formatting operation 440 then determines how the selected data should be formatted on the scrolling display device. In some embodiments, the formatting operation 440 formats according to user settings or default settings indicated. For example, in various embodiments, the different financial instrument data may be formatted with different fonts, font sizes, font colors, background colors or patterns, strikethrough lines, and/or other visual indicators. In some embodiments, formatting operation 440 determines the vertical and/or horizontal placement of the financial instrument data indicator on the dynamic order display. Once the data has been formatted properly, a presenting operation 450 presents the financial instrument data on the dynamic order display as is described in FIG. 5 below.

FIG. 5 illustrates a scrolling trade and order display window 500 extended by a user with a window enlargement action. It also represents a later point in time than the illustrative display of FIG. 3 and includes several additional trade and order data points. The financial information illustrated in FIG. 5 relates to trades and changes to the depth of market due the limit or stop/limit orders entering the market, modifications or cancellation of limit or stop/limit orders resting in the market, and other financial information.

In the portion of the scrolling trade and order display 502, a cancelled bid 512 is indicated by the strikethrough of a twenty-six lot order occurring below the dotted line 510 that divides the inside market. Following in sequence are a buy order 514 for nineteen entered at a price of 170005 and a ten lot bid 516 modified from a price of 170010 to 170020. Later in the sequence, there is a twenty-five lot trade 520 executed at the best bid price 170030 which is followed by a downward movement of the inside market as indicated by the marker 522a, a change in the background coloring, and a change in the background pattern of the market direction indicators 530a and 530b. The change in the background of the market direction indicators indicates that there has been a reversal in the market direction—that is, although the direction marker for that portion of the scrolling trade and order display 502 is no longer visible, the market direction for the portion 502 must have been upward.

A fifty-five lot trade 524 is then executed at the new best ask price of 170030. Still later in the sequence, there is a sell order 526 for twenty-six lots entered at the best ask price of 170030 and a cancelled ask 528 indicated by the strikethrough of a twenty-lot order occurring above the dotted line 510. Another downward movement of the inside market is indicated by the marker 522b, another alternating change in the background color, and no change in the background of the market direction indicators 530a and 530b since the market direction is a downward continuation.

Finally, a two hundred seventy five lot trade 542 is executed at the best bid price of 170025. The last trade direction marker 540 is pointing downward to indicate that the last trade 542 was executed at the best bid price.

In one or more embodiments presented herein, the trade data points lie vertically in the inside market zone. If the trade is executed at the best bid price, the trade data point is displayed slightly offset upward obscuring the mid point line 510 while a trade data point for a trade executed at the best ask price is displayed slightly offset downward obscuring the mid point line.

In some embodiments of the present invention the user can vary the vertical size of the scrolling trade and order display window between a minimum size and a maximum size. In some embodiments, the fonts used to display the trade and order data points are automatically adjusted to fit the new window size.

In other (or overlapping) embodiments, the fonts used to display the trade and order data points remain constant when the user resizes the window and the amount of information in the display changes creating a windowing-type effect. For example, as the length of the horizontal axis is decreased, the font sizes will remain constant and only a portion of the previously presented data will be presented in the resized display. Conversely, if the length of the horizontal axis is increased, and the font size remains constant, more data points will be displayed.

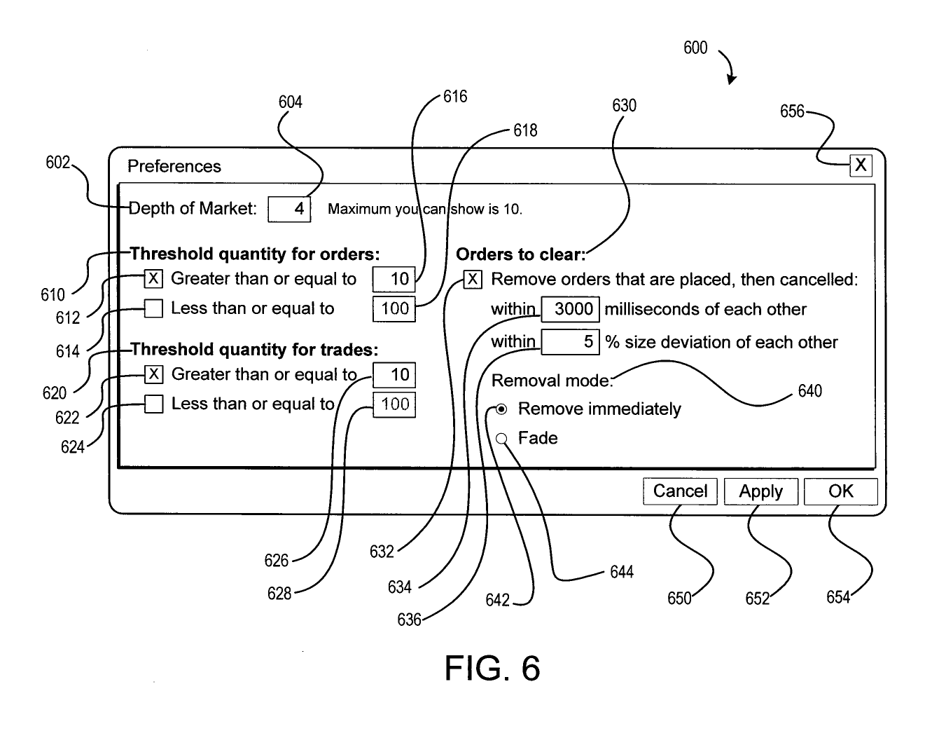

FIG. 6 illustrates an example of a graphical user interface 600 for adjusting parameters that control how the scrolling trade and order displays are rendered according to one or more embodiments of the present invention. In accordance with some embodiments, using a data entry box 604, the user can set the number of depth of market rows to include in scrolling trade and order displays. In accordance with one or more embodiments, the user can specify a set of threshold values 610 for filtering orders and another set of threshold values 620 for filtering trades.

If the checkbox 612 is checked and checkbox 614 is not checked, then orders with a quantity greater than or equal to the value specified in a data entry box 616 will be shown in the scrolling trade and order display. If the checkbox 612 is not checked and checkbox 614 is checked, then orders with a quantity less than or equal to the value specified in a data entry box 618 will be shown. If the both checkbox 612 and checkbox 614 are checked, the display will be limited to orders with a quantity greater than or equal to the value specified in a data entry box 616 and less than or equal to the value specified in a data entry box 618.

Similarly, if the checkbox 622 is checked and checkbox 624 is not checked, then trades with a quantity greater than or equal to the value specified in a data entry box 626 will be shown in the scrolling trade and order display. If the checkbox 622 is not checked and checkbox 624 is checked, then trades with a quantity less than or equal to the value specified in a data entry box 628 will be shown. If the both checkbox 622 and checkbox 624 are checked, the display will be limited to trades with a quantity greater than or equal to the value specified in a data entry box 616 and less than or equal to the value specified in a data entry box 628.

The effect of the user selections in the user interface 600 can be illustrated using FIG. 3. In FIG. 3, the text “>10 Orders>10 Trades”(350) changes in response to application of the user's selection in the threshold data entry fields.

In some embodiments, an order may be cleared from the scrolling trade and order flow display according to its time and size characteristics. In accordance with one or more embodiments, the user can specify a set of parameters 630 for clearing an order. If the checkbox 632 is checked, then any order that is placed, then cancelled with the time period specified in the data entry field 634 or any cancelled order that has a size within ‘n’ percent, where ‘n’ is specified in the data entry field 636, of a previously placed order will be cleared. The user may also specify the removal mode 640 to be either “Remove immediately”(642) or “Fade”(644).

While some financial markets provide a depth market that is limited to five bids and five asks, other financial market may provide many more bids and asks. With the user interface described in FIG. 6, a user may add additional rows to the scrolling trade and order display by entering the desired row count in the “Depth of Market” data entry field 604. As a result of the expanded display, additional orders further from the inside market can be displayed.

According to various embodiments, user interface 600 may include other user selectable graphical elements. For example, in one embodiment, user interface 600 may include one or more of a Cancel button 650, an Apply button 652, an OK button 654, and a close button 656. According to various embodiments, when the Apply button 652 is pressed, the user settings are applied to the scrolling trade and order display currently selected. When the OK button 654 is pressed in one embodiment, the user settings are applied to the scrolling trade and order display currently selected and the window displaying the Display Preferences is closed. In some embodiments, when either the Cancel button 650 or the Close button 656 is pressed, the window displaying the Display Preferences is closed without applying the user settings that may have been changed.

### Computer System Overview

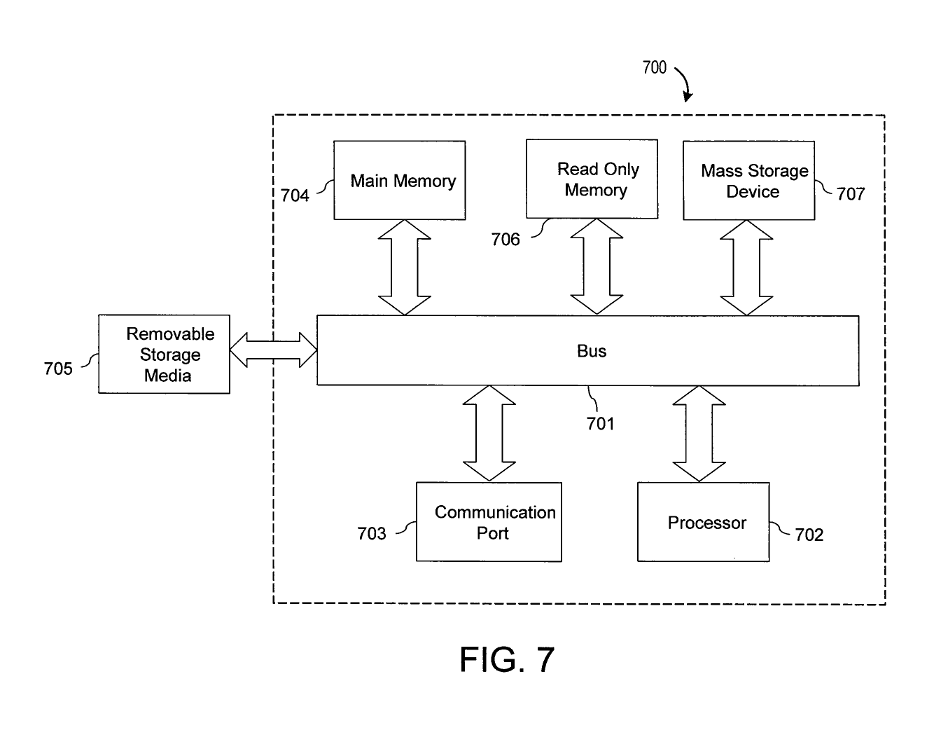

Embodiments of the present invention include various steps, a variety of which may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 7 is an example of a computer system 700 with which embodiments of the present invention may be utilized. According to the present example, the computer system includes a bus 701, at least one processor 702, at least one communication port 703, a main memory 704, a removable storage media 705, a read only memory 706, and a mass storage 707.

Processor(s) 702 can be any known processor, such as, but not limited to, an Intel® Itanium® or Itanium 2® processor(s), or AMD® Opteron® or Athlon MP® processor(s), or Motorola® lines of processors. Communication port(s) 703 can be any of an RS-232 port for use with a modem based dialup connection, a 10/100 Ethernet port, or a Gigabit port using copper or fiber. Communication port(s) 703 may be chosen depending on a network such a Local Area Network (LAN), Wide Area Network (WAN), or any network to which the computer system 700 connects.

Main memory 704 can be Random Access Memory (RAM), or any other dynamic storage device(s) commonly known in the art. Read only memory 706 can be any static storage device(s) such as Programmable Read Only Memory (PROM) chips for storing static information such as instructions for processor 702.

Mass storage 707 can be used to store information and instructions. For example, hard disks such as the Adaptec® family of SCSI drives, an optical disc, an array of disks such as RAID, such as the Adaptec family of RAID drives, or any other mass storage devices may be used.

Bus 701 communicatively couples processor(s) 702 with the other memory, storage and communication blocks. Bus 701 can be a PCI/PCI-X or SCSI based system bus depending on the storage devices used.

Removable storage media 705 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only examples of embodiments.

In conclusion, the present invention provides novel systems, methods and arrangements for presenting financial product data through a dynamic order display. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A computer-implemented method comprising:
receiving financial instrument data about a financial instrument from an electronic exchange;
displaying a scrolling trade and order display with a first axis representing a time and a second axis corresponding to a portion of a depth of market for the financial instrument; and
dynamically presenting the financial instrument data on the scrolling trade and order display in one or more indicative formats.

2. The computer-implemented method of claim 1, wherein the financial instrument data includes information about a depth of market, an inside market, buy orders, sell orders, cancelled orders, completed trades, bid volumes, ask volumes, and trade volumes.

3. The computer-implemented method of claim 1, wherein the one or more indicative formats are selected from combinations of font size, weight, color, and background pattern.

4. The computer-implemented method of claim 3, wherein the one or more indicative formats are selected from bright green text on a dark green background for an ask, bright red text on a dark red background for a bid, black text on a bright green background for a trade executed at the best ask price, gray text for a cancelled order, gray text with a green strikethrough for a cancelled bid, gray text with a red strikethrough for a cancelled ask, gray text with green strikethrough followed by bright green text on a dark green background with identical text for a modified bid, and gray text with a red strikethrough followed by bright red text on a dark red background with identical text for a modified ask.

5. The computer-implemented method of claim 1, further comprising displaying a dotted line across the scrolling trade and order display surrounded by a colored band highlighting an inside market associated with the financial instrument, wherein the dotted line and the colored band remain statically positioned on the scrolling trade and order display.

6. The computer-implemented method of claim 1, further comprising:
dynamically adjusting a price scale displayed on the second axis to reflect the current inside market prices within the colored band when the inside market associated with the financial instrument moves up or down; and
changing the background of the scrolling trade and order display to a second background color different from the first background color being used prior to the move of the inside market.

7. The computer-implemented method of claim 6, further comprising:
displaying a dotted line across the scrolling trade and order display; and
displaying a downward pointing marker below the dotted line if the inside market has moved down; and
displaying an upward point marker above the dotted line if the inside market has moved up.

8. The computer-implemented method of claim 6, further comprising:
displaying a market direction indicator at the top and at the bottom of the scrolling trade and order display indicating a market direction, wherein the market direction indicator includes a background aspect; and
changing the background aspect of the market direction indicator if the movement of the inside market reflects a reversal of the market direction; or
maintaining the background aspect of the market direction indicator if the movement of the inside market reflects a continuation of the market direction.

9. The computer-implemented method of claim 1, further comprising filtering the financial instrument data received from the electronic exchange based on rules for orders or rules of trades, wherein only financial instrument data meeting the rules of orders or the rules for trades will be dynamically presented on the scrolling trade and order display.

10. The computer-implemented method of claim 1, wherein the financial instrument data includes a plurality of events and the method further comprises:
determining if each of the plurality of events is a trade, a new or cancelled order, or a depth of market change;
if one of the plurality of events is a trade, then formatting the event as a trade and associating with the event one or more indicative formats corresponding to a trade;
if one of the plurality of events is a new or cancelled order, then if the event was a new order, determining if a price and quantity match in the financial data displayed on the scrolling trade and order display and formatting the event by associating with the event one or more indicative formats; and
if one of the plurality of events is a depth of market change, then generating a new or cancelled order corresponding to the depth of market change and if a new order was generated, then determining if a price and a quantity match in the financial data displayed on the scrolling trade and order display correspond to the new order, and formatting the event by associating with the event one or more indicative formats.

11. The computer-implemented method of claim 1, wherein the financial instrument data received from the electronic exchange includes order data points, trade data points, or data points describing changes in the depth of market.

12. The computer-implemented method of claim 11, wherein dynamically presenting the formatted financial instrument data includes displaying a numeric value representing a volume of one of the trade data points or a volume of one of the order data points by aligning the numeric value corresponding to a trade price or an order price of the financial instrument with a price on the second axis.

13. A trading application comprising:
an electronic exchange interface module communicably coupled to an electronic exchange and configured to receive financial instrument data of one or more transactions relating to a financial instrument from the electronic exchange;
a data processing module to process the financial instrument data that is received by the electronic exchange interface module and determine an activity type associated with each of the one or more transactions in the financial instrument data received from the electronic exchange;
a display generation module to present a scrolling trade and order display with a price scale axis corresponding to a portion of a depth of market for the financial instrument, the scrolling trade and order display further including a line across the scrolling trade and order display surrounded by a colored band highlighting an inside market associated with the financial instrument;
a dynamic display module to present each of the one or more transactions in the financial data on the scrolling trade and order display in one or more indicative formats corresponding to the activity type by the data processing module.

14. The trading application of claim 13, wherein the activity type determined from the one or more transactions in the financial instrument data received from the electronic exchange is a trade indicated by a trade descriptor, a new order indicated by a new order descriptor, a cancelled order indicated by an order cancellation descriptor, or change in the depth of market indicated by a change descriptor.

15. The trading application of claim 13, wherein the dynamic display module updates transactions presented on the scrolling trade and order display as new information about the financial instrument is received by the electronic exchange interface module.

16. The trading application of claim 13, wherein the one or more indicative formats selected by the dynamic display module include one or more of the following:
bright green text on a dark green background for an ask;
bright red text on a dark red background for a bid;
black text on a bright green background for a trade executed at the best ask price;
gray text for a cancelled order;
gray text with a green strikethrough for a cancelled bid;
gray text with a red strikethrough for a cancelled ask;
gray text with green strikethrough followed by bright green text on a dark green background with identical text for a modified bid; and
gray text with a red strikethrough followed by bright red text on a dark red background with identical text for a modified ask.

17. The trading application of claim 13, wherein the trading application is running on a client computer communicably coupled to a financial data server running a server-side application.

18. The trading application of claim 13, wherein the dynamic display module decreases the text size as the financial data relating to a trade or order is further away from the inside market.

19. The trading application of claim 13, further comprising an indicator module to display on the scrolling trade and order display a last trade direction marker on the price scale axis illustrating a last trade direction, an inside market change marker illustrating a change in the inside market, and a market direction indicator illustrating a market trend.

20. The trading application of claim 13, wherein the data processing module includes a filtering module to remove orders in the financial data that are placed and cancelled within a user-specified time period.

21. A system for trading financial instruments comprising:
a display device operable to display a graphical user interface;
a display input/output device in communication with the display device;
a microprocessor in communication with the display input/output device and operable to execute instructions stored in memory;
a memory having microprocessor executable instructions, wherein the microprocessor executable instructions cause the microprocessor to communicate display data to the display input/output device to cause a scrolling trade and order display to be displayed on the display device, wherein the scrolling trade and order display comprises with a time axis and a dynamic price scale axis corresponding to a portion of a depth of market for the financial instrument, the scrolling trade and order display further including a line across the scrolling trade and order display surrounded by a colored band highlighting an inside market associated with the financial instrument, wherein the dotted line and the colored band remain statically positioned on the scrolling trade and order display; and
the microprocessor executable instructions further cause the microprocessor to display the financial instrument data with one or more visual indicators on the scrolling trade and order display.

22. The system for trading financial instruments of claim 21, wherein the microprocessor executable instructions further cause the microprocessor to dynamically adjust the dynamic price scale axis so that the inside market remains within the colored band.

23. The system for trading financial instruments of claim 22, wherein the microprocessor executable instructions further cause the microprocessor to change a background color of the scrolling trade and order display from a first color to a second color starting at a time on the time axis corresponding to when the inside market changed.

24. A computer-readable storage medium containing a set of instructions capable of causing one or more processors to:
receive financial instrument data about a financial instrument from an electronic exchange or a pre-processing application;
display a scrolling trade and order display with a time axis and a price scale axis corresponding to a portion of a depth of market for the financial instrument, the scrolling trade and order display further including a line across the scrolling trade and order display surrounded by a colored band highlighting an inside market associated with the financial instrument; and
dynamically present the financial instrument data with one or more visual indicators on the scrolling trade and order display.

25. The computer-readable storage medium of claim 24, wherein the dotted line and the colored band remain statically positioned on the scrolling trade and order display as the price scale axis changes corresponding to the inside market.
